(19) United States
(12) Patent Application Publication
(10) Pub. No.: US 2025/0357829 A1
(43) Pub. Date: Nov. 20, 2025

(54) METHOD OF MANUFACTURING A CENTRIFUGAL WHEEL

(71) Applicant: Levitronix GmbH, Zürich (CH)

(72) Inventors: Thomas Nussbaumer, Zürich (CH); Thomas Schneeberger, Bern (CH)

(21) Appl. No.: 19/207,551

(22) Filed: May 14, 2025

(30) Foreign Application Priority Data
May 14, 2024 (EP) 24175815.0

(51) Int. Cl. H02K 15/021; H01F 13/00; H02K 15/142

(52) U.S. Cl. CPC H02K 15/021; H01F 13/006; H02K 15/142

(57) ABSTRACT

A method for manufacturing a rotor for devices having a magnetically levitated rotor includes providing an impeller configured to be magnetically levitated, has and having a magnetically active core, is the magnetically active core completely enclosed by a sheathing, the sheathing comprising a plastic, and at least one impeller element configured to interact with substances is provided on the sheathing, providing a magnetization device to demagnetize or magnetize the magnetically active core, the magnetization device comprising a receptacle into which the impeller or the rotor is capable of being inserted, inserting the impeller into the receptacle and demagnetizing the magnetically active core, separating the magnetically active core from the sheathing, attaching an encapsulation to the magnetically active core, the encapsulation comprising a plastic and completely enclosing the magnetically active core, and attaching at least one conveyor element to the encapsulation.

### CROSS-REFERENCE TO RELATED APPLICATION

This application claims priority to EP Application Serial No. 24175815.0, filed on May 14, 2024, the contents of which are hereby incorporated by reference.

### BACKGROUND

### Technical Field

The disclosure relates to a method for manufacturing a rotor for devices having a magnetically levitated rotor. Furthermore, the disclosure relates to a rotor manufactured according to the method, and to a magnetization device for carrying out the method.

### Background Information

In the biotechnological and in the pharmaceutical industry, electromagnetic rotary drives are frequently used, which are configured as devices having a magnetically levitated rotor. These include, inter alia, pump devices or mixing devices, in which the rotor, which forms the centrifugal wheel, is magnetically levitated. However, rotors of, for example, viscosity measuring devices, centrifuges, spin filters and/or fans can also be magnetically levitated. The pump devices, for example centrifugal pumps, serve, for example, to convey fluids through a circuit having a bioreactor. The mixing devices are used, for example, for preparing buffer solutions or cell culture media or also for continuously mixing and circulating the nutrient liquid in a bioreactor.

In the pharmaceutical industry, the highest demands must be placed on purity in the production of pharmaceutically active substances, in most cases, the components coming into contact with the substances must even be sterile. Similar requirements also arise in biotechnology, for example in the production, treatment or breeding of biological substances, cells or microorganisms, where an extremely high degree of purity must be ensured in order not to endanger the usability of the product produced.

In order to be able to meet the purity requirements for the process as well as possible, efforts are made to keep the number of components of a pump or mixing device coming into contact with the respective substances as small as possible. For this purpose, electromagnetically operated pump or mixing devices are known, in which the rotor, which usually forms the centrifugal wheel, is arranged in the mixing container. Then, a stator is provided outside the mixing container, which drives the rotor without contact through the wall of the mixing container and magnetically levitates it without contact in a desired position by magnetic or electromagnetic fields. This “contactless” concept particularly also has the advantage that no mechanical bearings or feedthroughs into the mixing container are required, which can be a cause of impurities or contaminations. The same also applies, of course, to the other devices mentioned having a magnetically levitated rotor.

A particularly efficient device of this type, by which substances are circulated or mixed in a bioreactor, is disclosed, for example, in EP 3 115 103 A1. Here, the stator and the rotor, which is arranged in the mixing container and forms the centrifugal wheel, form a bearingless motor. Here, the term bearingless motor means an electromagnetic rotary drive, in which the rotor is levitated completely magnetically with respect to the stator, wherein no separate magnetic bearings are provided. For this purpose, the stator is configured as a bearing and drive stator, which is both the stator of the electrical drive and the stator of the magnetic levitation. By the electrical windings of the stator, it is possible to generate a magnetic rotary field which, on the one hand, exerts a torque on the rotor, which brings about the rotation thereof, and which, on the other hand, exerts an arbitrarily adjustable transverse force on the rotor, so that the radial position thereof can be actively controlled or regulated.

The rotor of this mixing device constitutes an integral rotor, because it is both the rotor of the electromagnetic drive and the centrifugal wheel of the mixing device. In addition to the contactless magnetic levitation, the bearingless motor also affords the advantage of a very compact and space-saving configuration.

### SUMMARY

Although the number of components coming into contact with the substances can be greatly reduced by such contactlessly magnetically levitated mixers, it has been determined that the cleaning or the sterilization of these components is still associated with a very great outlay in terms of time, material and costs. Therefore, it is frequently necessary—as is also disclosed in the already cited EP 3 115 103 A1—to configure the components coming into contact with the substances as single-use parts for single use. Such a mixing device is then composed of a single-use device and a reusable device. In this case, the single-use device comprises those components which are intended for single use, that is to say, for example, the mixing container with the rotor, and the reusable device comprises those components which are used permanently, that is to say repeatedly, for example the stator.

Here, the term single-use parts refers to parts or components which can be used only once according to their intended purpose. After the use, the single-use parts are disposed of and replaced for the next use by new, that is to say not yet used, single-use parts.

FIG. 1 shows, in a schematic illustration, a mixer or a bioreactor 100′ as is known from the state of the art.

In order to indicate that the illustration in FIG. 1 is a device from the state of the art, the reference signs are in each case provided here with an inverted comma or with a dash. The bioreactor 100′ comprises a mixing container 110′ which is configured as a single-use part. In the configuration as a single-use part, the mixing container 110′ is frequently configured as a flexible plastic bag which is arranged in a dimensionally stable and reusable support container. The support container 120′ is configured, for example, from stainless steel or as a dimensionally stable plastic part.

The mixing container 110′ configured as a plastic bag is filled with a fluid F′, for example with a medium, a buffer solution or a cell broth. The mixing container 110′ comprises a dimensionally stable base plate 111′ with a cylindrical cup 112′ for receiving a centrifugal wheel 1′. The centrifugal wheel 1′ forms the rotor of a mixing device and comprises a magnetically active core (not visible in FIG. 1) which is completely enclosed by a sheathing 30′, wherein the sheathing 30′ is made of a plastic. A plurality of blades 20′ for mixing the fluid F′ is provided on the sheathing 30′. In the operating state, the magnetically active core of the centrifugal wheel 1′ is arranged in the cylindrical cup 112′.

The mixing device also comprises a stator 130′ which, together with the centrifugal wheel 1′, forms an electromagnetic rotary drive which is configured according to the principle of the bearingless motor. The stator 130′ is therefore configured as a bearing and drive stator, by which the centrifugal wheel 1′ can be driven magnetically in a contactless manner for rotation about a desired axis of rotation in the operating state and can be levitated magnetically in a contactless manner with respect to the stator 130′. The desired axis of rotation defines an axial direction A.

In FIG. 1, the stator 130′ is illustrated with a cutout, so that the arrangement of the centrifugal wheel 1′ in the stator 130′ can be seen better. The stator 130′, which is arranged outside the mixing container 110′, comprises a cup-shaped recess, into which the cylindrical cup 112′ of the mixing container 110′ can be inserted, so that the centrifugal wheel 1′ can be levitated magnetically in a contactless manner in the stator 130′.

In the state of the art, configurations of magnetic bearing devices are also known, where the rotor is configured as an external rotor and is arranged around a stator part.

The mixing container 110′ configured as a flexible plastic bag with the centrifugal wheel 1′ arranged therein are configured as a single-use device for single use, while the stator 130′ and the support container 120′ are configured as a reusable device for multiple use. After one use, the mixing container 110′ with the centrifugal wheel 1′ located therein is therefore removed from the reusable device and disposed of. For the next use, a new, that is to say not yet used, mixing container 110′ with a new, that is to say not yet used, centrifugal wheel 1′, which is arranged in the mixing container 110′, is then inserted into the stator 130′ and the support container 120′.

The configuration of the mixing container 110′ and of the centrifugal wheel 1′ as single-use parts has proven to be very advantageous in particular in the pharmaceutical and in the biotechnological industry, because it enables a very high flexibility in the various processes. Moreover, time-consuming and cost-intensive sterilization processes can be at least considerably reduced. Furthermore, the risk of cross-contamination can be considerably reduced.

An essential aspect is that the single-use parts can be manufactured as economically and cost-effectively as possible. In this case, particular importance is also attached to inexpensive, simple starting materials, such as, for example, commercially available plastics. Sustainability, environmentally conscious handling and responsible use of the available resources are also essential aspects in the design of single-use parts. The disclosure is dedicated to these aspects.

Furthermore, rotors, such as, for example, the centrifugal wheels mentioned, which are not configured as single-use parts, that is to say are used repeatedly in processes, also have a finite service life. That is to say that, after a certain number of uses, the rotor it is no longer usable and is disposed of. The most common reason for this is that elements of the rotor, such as, for example, the blades in the case of centrifugal wheels, are worn or the sheathing is worn, for example by aggressive substances. However, the magnetically active core of the rotor is not yet damaged or worn in most cases.

It is therefore an object of the disclosure to propose a method for manufacturing a rotor for devices having a magnetically levitated rotor, which method permits particularly cost-effective, environmentally friendly and sustainable manufacture of a rotor. In this case, the rotor should also be able to be configured, in particular, as a single-use part for single use. Furthermore, it is an object of the disclosure to propose a rotor, manufactured by this method, and a magnetization device for carrying out the method.

The subject matters of the disclosure which meet these objects are characterized by the features disclosed herein.

According to the disclosure, a method is therefore proposed for manufacturing a rotor for devices having a magnetically levitated rotor, comprising the following steps:
Providing an impeller that can be magnetically levitated, which has a magnetically active core, which is completely enclosed by a sheathing, wherein the sheathing comprises a plastic, and wherein at least one impeller element for interacting with substances is provided on the sheathing;
Providing a magnetization device, wherein the magnetization device is provided for demagnetization and/or magnetization of the magnetically active core, wherein the magnetization device comprises a receptacle into which the impeller and/or the rotor can be inserted;
Inserting the impeller into the receptacle and demagnetizing the magnetically active core;
Separating the magnetically active core from the sheathing;
Attaching an encapsulation to the magnetically active core, which encapsulation comprises a plastic and completely encloses the magnetically active core;
Attaching at least one conveying element to the encapsulation.

It goes without saying that the arrangement of the individual steps does not represent a sequence in which the individual steps of the method are carried out. The individual steps can be carried out in any combination. Furthermore, it goes without saying that the individual steps are carried out at least once. That is to say that it is also possible for one or more of the steps to be able to be carried out more than once. Likewise, steps can also be carried out in combination in one step. For example, the attachment of an encapsulation of the magnetically active core can take place in one step together with the attachment of the at least one conveying element in, for example, a casting process.

Furthermore, it goes without saying that the attachment of the encapsulation to the magnetically active core means that it can be attached both directly to the magnetically active core and also not directly, that is to say, for example, that at least one further layer can also be attached between the magnetically active core and the encapsulation.

A conveying element which is attached to the encapsulation is understood to mean an element which is provided for interacting with substance, in particular for conveying it. Thus, for example, these are blades in pump, mixing and/or fan devices, rotor bodies in centrifuge, viscosity sensor and/or spin filter devices.

According to the disclosure, it is therefore proposed to separate the magnetically active core from an existing impeller, for example an impeller which is configured as a single-use part and has already been used, and to use it for the manufacture of a new rotor. Thus, in particular, the magnetically active core can also be reused in the case of used single-use parts. Since the magnetically active core in the used impeller was protected from contact with substances by the sheathing, there is also no risk that cross-contamination could be caused by the reuse.

Since the magnetically active core is usually the most expensive component of the rotor, the reuse of the magnetically active core leads to a considerable cost reduction in the manufacture of the rotor.

According to the present state of the art, it is customary to use one or more permanent magnets for the magnetically active core of the rotor. In particular, metals of the rare earths or compounds or alloys of these metals are used as permanent magnets, because very strong permanent magnetic fields can be generated with these on account of their magnetic properties. Known and frequently used examples of these rare earths are neodymium and samarium. However, such metals constitute a considerable cost factor on account of their complex production and processing. Moreover, the disposal of such permanent magnets, for example after single-use, is frequently associated with problems or high expenditure, even from environmental aspects, as a result of which additional costs arise. It is therefore advantageous from economic, cost and environmental aspects, in particular also in single-use applications, for the magnetically active core of an impeller to be used for the manufacture of a new rotor after the impeller has been used. In particular, the CO₂ balance of the rotor can be greatly improved by the method according to the disclosure. The reuse of the magnetically active core for the manufacture of a new rotor is also particularly advantageous from the aspect of sustainability. The demagnetization of the magnetically active core before the separation of the magnetically active core from the sheathing is advantageous since it avoids the magnetically active core attracting impurities. Since the magnetically active core is completely separated from the sheathing in the course of the method, it can be ensured to a better extent by the preceding demagnetization that impurities do not accumulate on the magnetically active core.

The demagnetization permits reliable handling during the method since, thereafter, the magnetically active core no longer has an attracting effect and can therefore exert uncontrolled forces. The regulation of devices for carrying out the method (such as, for example, a manipulator device such as, for example, a robot) is also made more stable as a result and can be realized with less expenditure.

In the context of the present application, the term “demagnetization” means that the magnetic moment (dipole moment) of the magnetically active core is reduced to a value which is at most 40%, preferably at most 10%, of the magnetic moment which the magnetically active core has in the case of complete magnetization.

This corresponds physically to the equivalent definition that the magnetic flux density remaining in the magnet and/or on the magnet surface in a pole region, that is to say where the magnetic field enters or exits, has a residual magnetic flux density of at most 40%, preferably at most 10%, in comparison with complete magnetization.

Furthermore, various optional machining steps, such as, for example, mechanical machining with metallic tools or the encapsulation of the magnetically active core in an injection molding apparatus, can be carried out more easily if the magnetically active core is demagnetized.

According to a preferred way of proceeding, the at least one impeller element is removed from the sheathing.

According to a preferred way of proceeding, the magnetically active core has a magnetization direction, wherein the magnetization direction is determined before the demagnetization of the magnetically active core.

In principle, all methods known from the state of the art can be used for determining the magnetization direction.

Preferably, the determination of the magnetization direction takes place by a magnetic field measurement and/or by an identification, attached to the impeller, for the magnetization direction.

The magnetic field measurements can be carried out, for example, with the aid of magnetic field sensors. Likewise, the magnetization direction can also be determined with the aid of a test magnet, that is to say a magnet whose magnetization direction is known, and/or by a test object made of a magnetic or magnetizable material. The identification which is attached to the impeller can be either an optical marking, such as, for example, a dot or another geometric sign, or else a physical marking, such as, for example, a notch or a bore.

According to a preferred way of proceeding, the insertion of the impeller into the receptacle takes place in an aligned manner, wherein the alignment takes place on the basis of the determined magnetization direction.

In this case, the determination of the magnetization direction is advantageous since, as a result, the impeller or the rotor can be rapidly aligned in the correct orientation, preferably parallel to the field direction of the demagnetization/magnetization field of the magnetization device and inserted into the magnetization device.

According to a preferred way of proceeding, the impeller and/or the rotor are fixed in the receptacle, such that no translational and/or rotational movement of the impeller and/or of the rotor is possible.

This is advantageous since an undesired alignment of the magnetically active core is prevented as a result. Otherwise, it would be possible for the magnetically active core to align itself in the demagnetization/magnetization field and therefore to be arranged in a different manner, for example in the opposite direction to that required for the demagnetization/magnetization process. This is advantageous precisely in the demagnetization since, in this case, an opposing field to the field of the magnetically active core is generated and the latter would rotate as a result without fixing, as a result of which the demagnetization would not function reliably.

Furthermore, the determination of the magnetization direction, the alignment of the magnetically active core in the receptacle, and the fixing in the receptacle are advantageous since, as a result, the occurrence of field distortions and the retention of residual harmonic magnetizations is prevented. Residual harmonic magnetizations are to be avoided in these applications since they are disadvantageous for, for example, complete demagnetization and since they promote the attraction of undesired impurities by the magnetically active core. Residual harmonic magnetizations are also disadvantageous during the operation of the rotors in the devices in which they are magnetically levitated. For example, they have a negative influence on the position sensor system, which has effects on the magnetic levitation of the rotor, as a result of which the levitation stability is impaired. Furthermore, this results in vibrations during the operation of the device, which leads to higher losses.

According to a preferred way of proceeding, the demagnetization of the magnetically active core takes place by a decaying alternating field.

In this case, the decaying alternating field can have, for example, a decaying sinusoidal form, but it can also take place, for example, stepwise or in another form.

In this case, the decaying alternating field is generated by one or more coils.

Preferably, the decaying alternating field has a frequency F, wherein the magnetically active core comprises a permanent-magnetic material, wherein the permanent-magnetic material has a magnetic permeability and an electrical conductivity, wherein the magnetically active core has an axial extent in an axial direction and a radial extent in a radial direction, wherein the axial direction and the radial direction are arranged perpendicular to one another, wherein the decaying alternating field has a penetration depth into the magnetically active core, wherein the penetration depth is at least equal to half the axial extent and/or the radial extent, and wherein the frequency F (in Hertz) satisfies the relationship

$$F < \frac{1}{π \cdot μ \cdot σ \cdot {T}^{2}}$$

Where μ is the magnetic permeability for the magnetic field strength H at H=0, where H is specified in the unit A/m (amperes per meter), where σ is the electrical conductivity of the permanent-magnetic material in the unit S/m (Siemens per meter), and where T specifies the penetration depth (meters). In this case, the penetration depth must be at least equal to half the axial extent and/or the radial extent of the magnetically active core. That is to say, in other words, the penetration depth must be so large that it reaches every spatial point in the magnetically active core. This is necessary so that interaction with every magnetic moment which is comprised by the magnetically active core is possible.

For permanent-magnetic materials which comprise neodymium-iron-boron (NdFeB), the frequency is preferably less than 600 Hz, particularly preferably less than 150 Hz.

In general, that is to say not restricted only to permanent-magnetic materials which comprise NdFeB, the frequency is preferably less than 300 Hz, and particularly preferably less than 200 Hz.

The field strength in the magnet, during the demagnetization, at a point in time, preferably at the first deflection of the alternating field, preferably reaches a negative field strength of less than −HcJ, where −HcJ is that negative field strength at which the polarization J in the magnet corresponds to the value J=0.

Particularly preferably, during the demagnetization by the decaying alternating field, a magnetic operating point of the permanent magnet, defined by a graphic coordinate of the magnetic flux density B and the magnetic field strength H, that is to say the operating point (B, H) in the coordinate plane of the magnetic characteristic map, defined by the axes B and H, alternates repeatedly over a straight line with polarization J=0, preferably at least four times, particularly preferably at least six times.

According to a preferred way of proceeding, a measurement of the residual magnetization of the magnetically active core takes place after the demagnetization.

A magnetically active core that has not been sufficiently demagnetized can be demagnetized more thoroughly by demagnetizing it two or more times.

This is advantageous since it is thereby possible to check whether the impeller can already be further processed or whether a new demagnetization has to be carried out.

According to a preferred way of proceeding, the magnetically active core is magnetized after the attachment of the encapsulation and/or after the attachment of the at least one conveying element to the encapsulation.

That is to say, the magnetization can be carried out directly after the attachment of the encapsulation or also after the at least one conveying element is attached to the encapsulation.

In order to separate the magnetically active core from the sheathing, several variants are possible. For example, the separation of the magnetically active core from the sheathing takes place by mechanical machining.

The mechanical machining comprises, for example, cutting or drilling or grinding or milling.

A preferred variant is that the separation of the magnetically active core from the sheathing takes place by a mechanical pressing device. For this purpose, it is possible to press the magnetically active core through the sheathing by the pressing device and thereby to press it out of the sheathing. In this case, it is preferred that, during the pressing operation, at least one part of the sheathing is arranged between the magnetically active core and the pressing device, such that the magnetically active core is protected from damage.

If the magnetically active core is of annular configuration, it is preferred that, for the separation of the magnetically active core from the sheathing, a central bore is made which extends completely through the sheathing in an axial direction. The sheathing is thus drilled through completely in the axial direction and preferably in the central region of the sheathing, such that a cylindrical opening arises in the center of the sheathing. Subsequently, the sheathing is of annular configuration.

A further variant is that heat is supplied to the sheathing in order to separate the magnetically active core from the sheathing. Thus, for example, the plastic from which the sheathing is made can be softened by melting or melted in order to separate the magnetically active core from the sheathing. In particular, it is also possible to combine such a thermal process with mechanical machining in order to separate the magnetically active core from the sheathing. The sheathing can be softened, for example, by supplying heat, in order then to press the magnetically active core out of the sheathing, for example by a pressing device.

According to a preferred way of proceeding, the encapsulation is produced by encapsulation of the magnetically active core with a plastic. This can take place, for example, in an injection molding process in an injection molding apparatus.

A further preferred way of proceeding is that the encapsulation and the at least one conveying element are produced in a single injection molding process. That means that the encapsulation and the at least one conveying element are produced together in a single injection molding process. Of course, it is optionally possible for the final form of the at least one conveying element and/or of the encapsulation to be produced after this injection molding process by mechanical finishing, for example by a chip-removing process.

According to another preferred way of proceeding, the encapsulation is produced by joining several components.

For this purpose, it is possible, for example, for the encapsulation to comprise a cup and a cover, wherein the magnetically active core is inserted into the cup, and wherein the cover is welded to the cup. The encapsulation is therefore produced from two plastic parts, namely from the cup into which the magnetically active core is inserted and from the cover with which the cup is closed. The welding of the cup to the cover can take place, for example, by mirror welding, ultrasonic welding or infrared welding. Of course, other joining methods are also possible in order to connect the cover to the cup, for example adhesive bonding or screwing.

A further preferred way of proceeding is that the encapsulation is produced by a sintering process. The encapsulation is then produced from a powder or from a granulate which is pressed onto the magnetically active core using pressure and optionally a temperature treatment, in such a way that the magnetically active core is completely enclosed.

The at least one conveying element is fastened to the encapsulation, for example, by welding. In the case of configurations with a plurality of conveying elements, it is possible here that each conveying element is fastened individually to the encapsulation, for example by welding or adhesive bonding, or that firstly a base plate with the conveying elements arranged and fixed thereon is produced, and this base plate is then fixed on the encapsulation.

In particular for applications in the biotechnological or the pharmaceutical industry, it is preferred that the encapsulation and the at least one conveying element consist of a biocompatible plastic.

For example, the encapsulation and the at least one conveying element can consist of polyethylene (PE) or polypropylene (PP).

Furthermore, a rotor for devices having a magnetically levitated rotor, manufactured by the method according to the disclosure, is proposed.

According to a preferred embodiment, the rotor is configured as a single-use part.

Furthermore, a magnetization device for carrying out a method according to the disclosure is proposed, comprising a generator unit, a coil unit and a receptacle into which the impeller and/or the rotor can be inserted and with which the magnetically active core can be demagnetized and/or magnetized.

In this case, the generator unit generates a charging voltage as DC voltage for internal capacitors/capacitances of the generator unit via a charging device, preferably by connection to a power grid. Preferably, the generator unit furthermore has mechanisms to electrically separate the capacitors/capacitances of the generator unit completely or partially from the charging device, and instead to electrically connect them to the coil unit. As a result, the generator unit can generate the demagnetization/magnetization voltage and/or the demagnetization/magnetization current for the coil unit by discharging the capacitors/capacitances via the coil unit. The generator unit can of course contain further components to perform its function, such as, for example, a connectable freewheeling diode or a component for the same purpose to avoid alternating currents in the coil unit during magnetization, that is to say the impressing of a magnetic field for the purpose of magnetization.

That is to say, the impeller can be demagnetized, and the rotor can be magnetized using the magnetization device.

According to a preferred embodiment, the coil unit comprises the receptacle and at least one coil.

In this case, the number of coils in the coil unit is preferably selected as a function of the number of pole pairs of the magnetically active core.

This has the advantage that, as a result, the demagnetization/magnetization process is adapted to the respective magnetically active core.

Preferably, the at least one coil is configured such that the magnetically active core is located in a largely homogeneous field region during the demagnetization/magnetization. This is preferably achieved by virtue of the fact that the at least one coil spans a spatially larger field region in which the magnetically active core is demagnetized/magnetized than the spatial size of the field region of the magnetically active core itself.

In a preferred embodiment, several rotors and/or impellers can be simultaneously demagnetized/magnetized in the receptacle. This increases the cycle rate.

According to a preferred embodiment, a fixing element can be inserted into the receptacle, in which fixing element the impeller and/or the rotor can be fixed in a predefined position, such that no translational and/or rotational movement of the impeller and/or of the rotor is possible.

Embodiments in which the receptacle itself comprises a fixing element are also possible.

Preferably, the predefined position represents a magnetization position, wherein, in the magnetization position, the magnetization direction of the magnetically active core is aligned parallel to one direction, wherein the direction represents the field direction of a magnetization field or of a demagnetization field.

According to a preferred embodiment, the fixing element is configured in two parts as an upper part and lower part, wherein preferably the upper part and lower part can be connected to one another by a force-fitting connection and/or a form-fitting connection.

According to a preferred embodiment, the magnetization device comprises an oscillating circuit, wherein the oscillating circuit comprises at least one resistance component with an electrical resistance, at least one capacitance component with a capacitance and at least one inductance component with an inductance, wherein the oscillating circuit has an oscillating circuit characteristic value, wherein the oscillating circuit characteristic value must satisfy the relationship

$$SK = \frac{R}{2} \cdot \sqrt{\frac{C}{L}} < 1$$

during the demagnetization.
In this case, R is the electrical resistance, C is the capacitance and L is the inductance.

Preferably, the capacitance C multiplied by half the square of the charging voltage is greater than an energy capacitance which is required in order to demagnetize the magnetically active core.

The oscillating circuit characteristic value can be regulated and/or set according to a predefined value via a regulating device which preferably comprises the magnetization device. For example, the capacitance can be set by connecting or removing capacitances connected in parallel.

Further advantageous measures and embodiments of the disclosure are described herein.

### BRIEF DESCRIPTION OF THE DRAWINGS

The disclosure is explained in more detail below on the basis of exemplary embodiments and on the basis of the drawing. In the drawing show:

FIG. 1 is a schematic illustration of a bioreactor which is known from the state of the art,

FIG. 2 is a perspective illustration of a first exemplary embodiment of a rotor having conveying elements arranged thereon, which rotor is manufactured by a method according to the disclosure,

FIG. 3 is a sectional illustration of the exemplary embodiment from FIG. 2 in a section along the axial direction,

FIG. 4 is a perspective illustration of a variant for the configuration of the magnetically active core,

FIG. 5 is a schematic sectional illustration of an impeller which can be used for a method according to the disclosure,

FIG. 6 is the impeller from FIG. 5 after removal of all impeller elements,

FIG. 7 is a variant for the configuration of the magnetically active core of the impeller,

FIG. 8 is a schematic sectional illustration of a second exemplary embodiment of a rotor which is manufactured by a method according to the disclosure,

FIG. 9 is a schematic sectional illustration of a third exemplary embodiment of a rotor which is manufactured by a method according to the disclosure,

FIG. 10 is a schematic sectional illustration of a fourth exemplary embodiment of a rotor which is manufactured by a method according to the disclosure,

FIG. 11 is a schematic illustration of a magnetization device with a first variant of a coil unit,

FIG. 12 is a schematic sectional illustration along the section line C-C′ of the coil unit from FIG. 11,

FIG. 13 is a schematic illustration of an opened fixing element for a rotor/impeller,

FIG. 14 is a schematic illustration of a second variant of a coil unit, and

FIG. 15 is a schematic illustration of a third variant of a coil unit.

### DETAILED DESCRIPTION

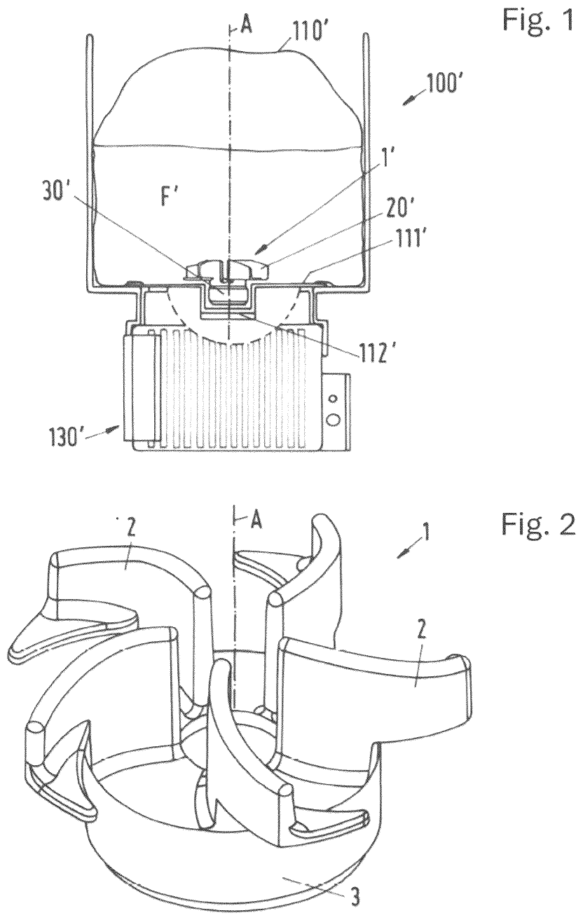

As already explained above, FIG. 1 shows a schematic illustration of a bioreactor 100′ which is known from the state of the art. The bioreactor 100′ comprises a mixing device having a contactlessly magnetically levitated and contactlessly magnetically driven centrifugal wheel 1′ for mixing at least two substances.

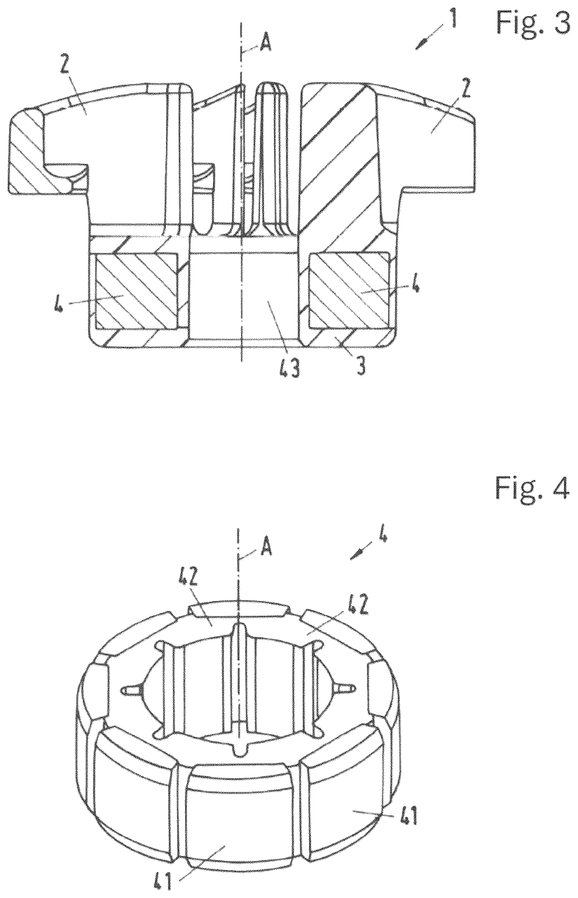

FIG. 2 shows, in a perspective illustration, an exemplary embodiment of a rotor having conveying elements arranged thereon, which rotor is manufactured by a method according to the disclosure. The rotor is denoted overall by the reference sign 1. The rotor 1 is configured for rotation about an axial direction A. For better understanding, FIG. 3 shows the rotor 1 from FIG. 2 in a sectional illustration, wherein the section takes place along the axial direction A.

The rotor 1 is configured as a centrifugal wheel for a pump device for conveying a fluid or for a mixing device for mixing at least two flowable substances. In particular, the rotor 1 for such a bioreactor 100′ can be configured with a mixing device, as is illustrated in FIG. 1. The term “flowable substances” comprises, in addition to fluids, in particular also pulverulent substances. The mixing device can thus also be used, in particular, for mixing a powder and a liquid, e.g., in order to dissolve the powder in the liquid.

In particular, the rotor 1 is configured for a preferably contactless magnetic levitation and for a contactless drive for rotation about the axial direction A. The rotor 1 can be inserted, for example, into the stator 130′ (FIG. 1), which is configured as a bearing and drive stator. The rotor 1 then forms an electromagnetic rotary drive together with the stator 130′, wherein the rotor 1 can be driven magnetically in a contactless manner for rotation about the axial direction A in the operating state and can be levitated magnetically in a contactless manner with respect to the stator 130′.

The rotor 1 illustrated in FIG. 2 and FIG. 3 is configured for an electromagnetic rotary drive which is configured as an internal rotor, i.e., the stator 130′ is arranged around the rotor. Of course, it is also possible that the rotor 1 is configured for an electromagnetic rotary drive which is configured as an external rotor, i.e., the stator is arranged radially on the inside in the rotor 1, such that the rotor 1 extends in the circumferential direction around the stator. Such a configuration as an external rotor is shown, for example, in FIG. 2 of EP 3 115 103 A1.

The rotor 1 comprises a magnetically active core 4 and an encapsulation 3 which consists of a plastic and completely encloses the magnetically active core 4. The encapsulation 3 therefore ensures that the magnetically active core 4 does not come into contact with the conveyed fluid or the substances to be mixed in the operating state.

A plurality of conveying elements 2, which are configured here as blades, are arranged on the encapsulation 3, which conveying elements are fixed on the encapsulation 3. In the exemplary embodiment illustrated in FIG. 2 and FIG. 3, precisely five conveying elements 2 are provided with exemplary character. It goes without saying that more than five or less than five conveying elements 2 can be provided in other configurations of the rotor 1. The configuration of the individual conveying elements 2, as is clearly visible in particular in FIG. 2, is also of purely exemplary character. There is a large plurality of possibilities for the configuration of the individual conveying elements.

The conveying elements 2 preferably consist of plastic and can be configured, for example, in one piece with the encapsulation 3. Of course, it is also possible to produce the individual conveying elements 2 or the entirety of the conveying elements 2 in a separate production process and then to connect them to the encapsulation 3 of the magnetically active core 4, for example by a welding process.

In the exemplary embodiment of the rotor 1 described here, the magnetically active core 4 is configured as a permanent-magnetic ring with a central opening 43. In other configurations, the magnetically active core 4 is configured as a magnetically active disk.

The “magnetically active core” 4 of the rotor 1 means that region of the rotor 1 which interacts magnetically with the stator 130′ for the generation of the magnetic levitation forces and for the torque formation.

The magnetically active core 4 comprises at least one permanent magnet. Configurations in which the magnetically active core 4 comprises several permanent magnets 41 (see, for example, FIG. 4) are also possible. In the exemplary embodiment of the rotor 1 illustrated in FIG. 2 and FIG. 3, the magnetically active core 4 consists completely of a permanent-magnetic material, such that the magnetically active core 4 is the permanent magnet. The magnetically active core 4 is magnetized, for example, in the radial direction.

Permanent magnets are usually those ferromagnetic or ferrimagnetic substances which are hard-magnetic, that is to say have a high coercive field strength. The coercive field strength is that magnetic field strength which is required in order to demagnetize a substance. In the context of this application, a permanent magnet is understood to mean a substance or a material which has a coercive field strength, more precisely a coercive field strength of the magnetic polarization, which is more than 10 000 A/m.

Configurations in which the magnetically active core 4 of the rotor 1 comprises both soft-magnetic materials and permanent-magnetic materials are also possible. FIG. 4 shows a perspective illustration of such a variant for the configuration of the magnetically active core 4.

The magnetically active core 4 comprises a main body 42, on which or in which a plurality of permanent magnets 41 are arranged. The main body 42, which is of annular configuration in the variant illustrated in FIG. 4, consists of a soft-magnetic material, preferably a ferromagnetic or a ferrimagnetic material. Suitable soft-magnetic materials are, in particular, iron, nickel-iron, cobalt-iron, silicon-iron or Mu metal. The magnetically active core 4 also comprises a plurality of permanent magnets 41, here eight permanent magnets 41 with exemplary character. Each permanent magnet 41 is of segment-shaped configuration. The permanent magnets 41 are arranged radially on the outside along the circumferential surface on the main body 42 and fastened to the main body 42, for example by an adhesive bond. The main body 42 serves as an annular back iron for guiding the magnetic flux between the permanent magnets 41.

Configurations of the magnetically active core in which the main body 42 is arranged radially on the outside and surrounds the permanent magnets 41 in the circumferential direction are also possible. It is also possible for the main body 42 to have recesses, into which the permanent magnets 41 are placed or inserted.

Configurations in which the magnetically active core 4 does not consist completely of a permanent-magnetic material, but rather, for example, of the ferromagnetic main body 42 and the permanent magnets 41, are advantageous, for example, if, in the case of large centrifugal wheels 1, it is intended to reduce the costs by saving permanent-magnetic material.

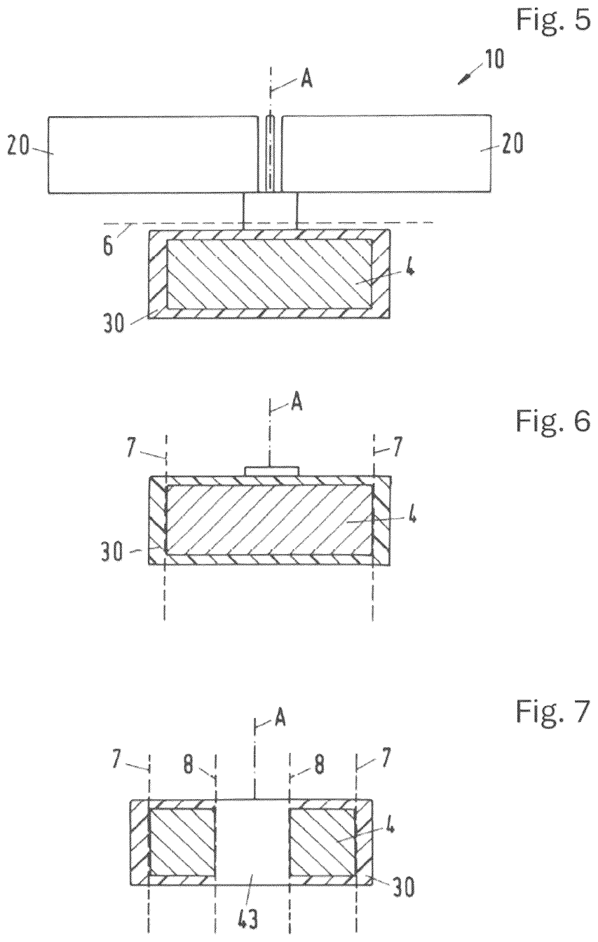

In the following, an exemplary embodiment of a method according to the disclosure for manufacturing a rotor, for example the rotor 1 illustrated in FIG. 2 and FIG. 3, which is configured as a centrifugal wheel, is explained in more detail on the basis of FIG. 5 to FIG. 7.

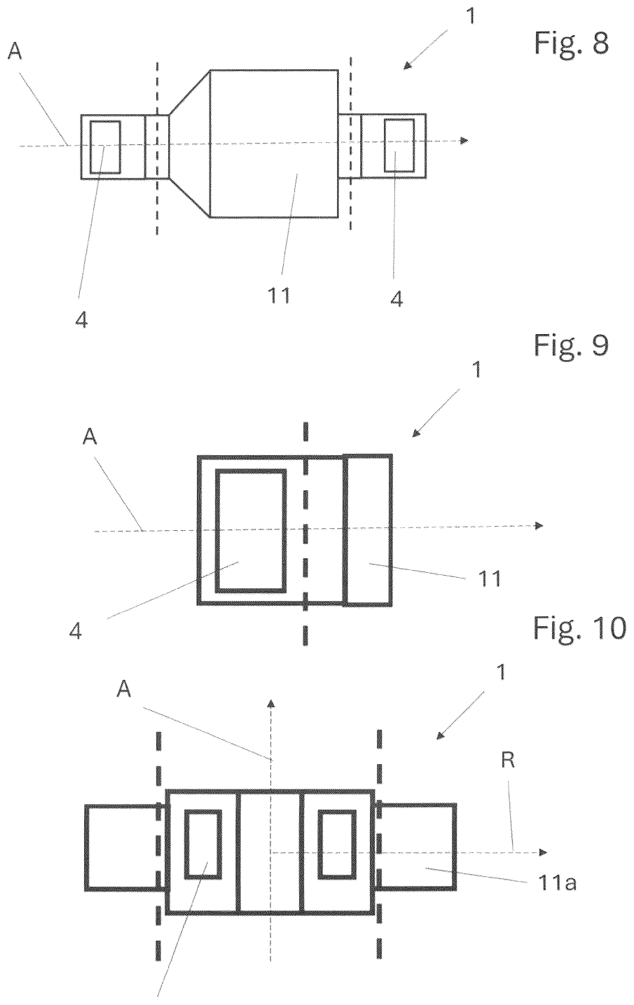

However, it is also possible for the method according to the disclosure to also be used for rotors which are configured, for example, according to the exemplary embodiments in FIGS. 8 to 10.

Firstly, in a first processing step, an impeller 10 that can be magnetically levitated is provided, which has a magnetically active core 4 which is completely enclosed by a sheathing 30, wherein the sheathing 30 consists of a plastic. A plurality of impeller elements 20 for interacting with a fluid and/or one or more substances is provided on the sheathing 30. The impeller 10 is, for example, the impeller 10 of a pump device for conveying a fluid or the impeller 10 of a mixing device for mixing at least two flowable substances.

The impeller 10 can also be, in particular, a centrifugal wheel 1′ (FIG. 1) or a rotor 1, as is described on the basis of FIG. 2 and FIG. 3. In particular if the impeller 10 is configured for single use, the impeller 10 is preferably a single-use part, for example a centrifugal wheel and/or rotor 1, 1′, which has already been used for one use and now has to be replaced by a new, that is to say unused, part.

The impeller 10 is therefore preferably, but not necessarily, such an impeller which has been configured for single use and has already been used once. Instead of disposing of the complete impeller 10, it is now proposed to separate the magnetically active core 4 from the rest of the impeller 10, and then to use the magnetically active core 4 for the manufacture of a new rotor 1, in particular of such a rotor 1 which is configured for single use.

FIG. 5 shows, in a schematic sectional illustration, the impeller 10 which is used for the exemplary embodiment described here. After the impeller 10 has been provided, in a next processing step, all impeller elements 20 are removed from the sheathing 30. This can take place, for example, by mechanically removing the impeller elements 20, for example by cutting along the dashed line 6 in FIG. 5. FIG. 6 shows the impeller 10 from FIG. 5 after removal of all impeller elements 20.

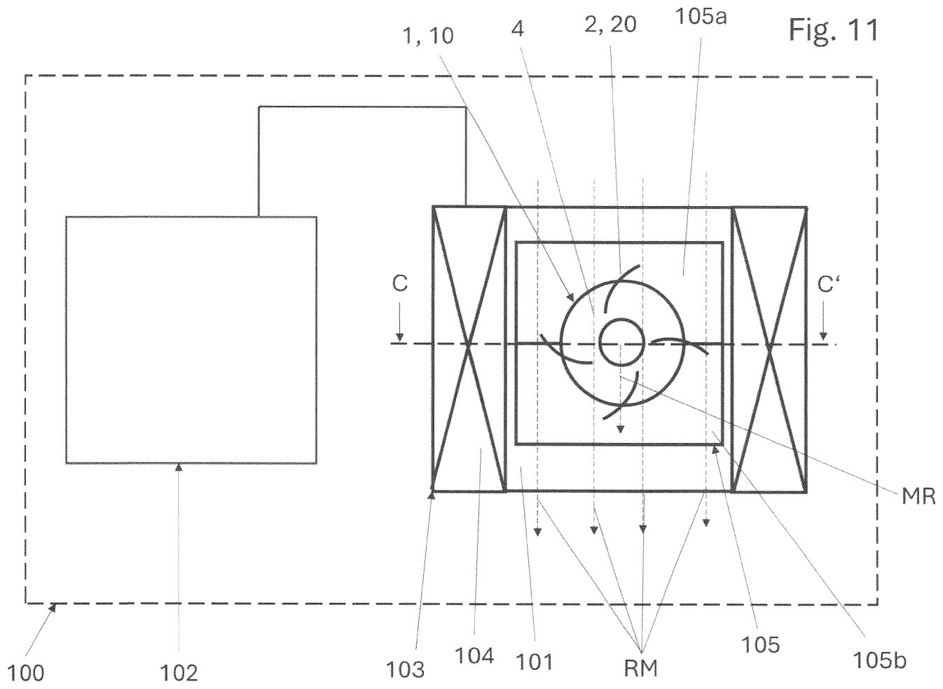

In a next processing step, a magnetization device 100 (FIG. 11) is provided which is provided for demagnetization of the magnetically active core 4. The magnetization device 100 comprises a receptacle 101 into which the impeller 10 is inserted and subsequently the magnetically active core 4 is demagnetized.

The demagnetization particularly preferably already takes place before the removal of the impeller elements 20 from the sheathing 30. The demagnetization of the magnetically active core 4 has the advantage that the further machining, for example the machining with metallic tools and machines, is considerably easier if the magnetically active core 4 is demagnetized. Moreover, the risk of contaminants being attracted by the magnetically active core 4 and accumulating during the machining can also be avoided.

Removing the impeller elements 20 or parts thereof prior to demagnetization is preferred, for example, if the impeller elements 20, due to their size, lead to poor utilization of the demagnetization field in the magnetization device 100. This would be the case, for example, if the impeller 10 with impeller elements 20 is too large and would not fit into the magnetization device 100, or if the dimensions of the impeller elements 20 would require a larger magnetization device 100. Another advantage of removing the impeller elements 20 or parts thereof before demagnetization is, for example, that it is possible to insert several magnetically active cores 4 into the magnetization device 100.

The demagnetization of the magnetically active core 4 preferably takes place by electromagnetic alternating fields. The process of demagnetization can in this case take place in several steps. The demagnetization preferably takes place until the remanence of the magnetically active core disappears or is at least approximately equal to zero, preferably less than 40% of the original value and particularly preferably less than 10% of the original value. As already mentioned, the term “demagnetization” means a reduction of the magnetic moment of the magnetically active core 4 to a value which is preferably at most 40% and particularly preferably at most 10% of the magnetic moment which the magnetically active core 4 has in the case of complete magnetization.

A detailed description of the mode of operation of the magnetization device 100 can be found in the description of the figures of FIGS. 11 to 15.

In a next processing step, the magnetically active core 4 is now separated from the sheathing 30. In FIG. 5 and FIG. 6, the magnetically active core 4 is configured as a disk. FIG. 7 shows, in an illustration analogous to FIG. 6, a configuration of the magnetically active core 4 as a ring, that is to say with the central opening 43.

The magnetically active core 4, which has a diameter in the radial direction R and an axial height, wherein the axial height specifies the extent of the magnetically active core 4 in the axial direction A, is preferably configured to be passively magnetically levitatable with respect to tilting. This is achieved by virtue of the magnetically active core 4 preferably having a diameter which is greater than twice the axial height.

There are numerous possibilities for the separation of the magnetically active core 4, some of which are mentioned below.

Mechanical machining methods are suitable, in particular. Thus, the magnetically active core 4 can be pressed out of the sheathing 30, for example by a mechanical pressing device. For this purpose, for example, the sheathing 30 with the core 4 arranged therein is inserted into a mechanical pressing device in such a way that the pressing device exerts a force acting in the axial direction A, in particular on the region in which the magnetically active core 4 is arranged. This region is indicated in FIG. 6 by the two dashed lines with the reference sign 7. The magnetically active core 4 is then pressed through the sheathing 30 in the axial direction A by the pressing device along the lines 7 and can be separated from the sheathing 30 in this way.

Alternatively or additionally, it is also possible to separate the magnetically active core 4 from the sheathing 30 by a machining or a chip-removing process. Such mechanical processes comprise, for example, cutting, drilling, sawing, milling, turning or grinding. For example, the sheathing can be cut open along the lines 7 or ground or milled away apart from the lines 7.

If the magnetically active core 4 is of annular configuration and therefore has the central opening 43, the separation of the magnetically active core 4 preferably takes place in two separate steps. Firstly, a central bore is carried out along the dashed lines 8 in FIG. 7 in order to remove the sheathing 30 from the central opening 43 of the magnetically active core 4. This bore can be combined with grinding or milling. After the sheathing 30 has been removed from the central opening 43—as is illustrated in FIG. 7—the further separation of the magnetically active core 4 from the sheathing 30 takes place as described above, that is to say for example by the mechanical pressing device, by which the magnetically active core 4 is pressed out of the sheathing 30.

Alternatively to or in combination with the mechanical machining for separating the magnetically active core 4 from the sheathing 30, thermal machining is also possible in order to separate the magnetically active core 4 from the sheathing 30.

For example, the sheathing 30 consisting of a plastic can be melted by supplying heat, such that the magnetically active core 4 can be removed from the sheathing 30. However, it is also possible to combine the thermal machining with mechanical machining. For example, the sheathing 30 can be softened or plasticized by supplying heat and then the magnetically active core 4 can be pressed out of the sheathing 30 by a mechanical pressing device.

After the magnetically active core 4 has been completely separated from the sheathing 30 and optionally cleaned, it serves as a starting component for the manufacture of a new rotor 1. The completion of the rotor 1 can then be carried out, for example, analogously in the same way as is carried out with a new, that is to say previously not yet used, magnetically active core 4.

The magnetically active core 4 is provided with the encapsulation 3 (FIG. 2, FIG. 3) made of a plastic which completely and preferably hermetically tightly encloses the magnetically active core 4. Subsequently, the plurality of conveying elements 2 is attached and fixed on the encapsulation 3.

Several processes are possible for the production of the encapsulation 3. For example, the magnetically active core 4 can be encapsulated with a plastic. This can take place, in particular, in an injection molding process in an injection molding apparatus.

Particularly preferably, the encapsulation 3 and the at least one conveying element 2 are produced in a single injection molding process. That means that the encapsulation 3 and the at least one conveying element 2 are produced together in a single injection molding process. Of course, it is optionally possible for the final form of the at least one conveying element 2 and/or of the encapsulation 3 to be produced after this injection molding process by mechanical finishing, for example by a chip-removing process.

Furthermore, it is possible to produce the encapsulation 3 by joining several components. Thus, the encapsulation 3 can comprise, for example, a dimensionally stable cup and a dimensionally stable cover which is configured for closing the cup. The magnetically active core 4 is then inserted into the cup, the cover is placed onto the cup and is then fixedly connected to the cup by a joining process. The joining process is, for example, a welding process such as infrared welding. However, the joining can also be carried out by other methods, for example by adhesive bonding or by screwing.

A further possibility is to produce the encapsulation 3 by a sintering process. The encapsulation is then produced from a powder or from a granulate which is pressed onto the magnetically active core 4 using pressure and optionally a temperature treatment, in such a way that the magnetically active core 4 is completely enclosed. This possibility is also suitable in particular if the plastic from which the encapsulation 3 is made cannot be processed by an injection-molding method, as is the case, for example, for polytetrafluoroethylene (PTFE).

Once the encapsulation has been completed, the at least one conveying element 2 is fixed on the encapsulation 3, for example by welding.

In particular for applications in the pharmaceutical industry or in the biotechnological industry, for example for applications in a bioreactor, biocompatible plastics, in particular polyethylene (PE) or polypropylene (PP), are preferred for the encapsulation 3 and/or for the at least one conveying element 2.

Of course, other plastics are also suitable, such as, for example, polyvinyl chloride (PVC), low density polyethylene (LDPE), ultra-low density polyethylene (ULDPE), high density polyethylene (HDPE), ethylene vinyl acetate (EVA), polyethylene terephthalate (PET), polyvinyl fluoride (PVDF), acrylonitrile butadiene styrene (ABS), polyacrylic (PA), polycarbonate (PC), polysulfones such as, for example, polysulfone (PSU).

Since the magnetically active core 4 has been demagnetized before the separation from the sheathing 30, the magnetically active core 4 is magnetized again using the magnetization device 100 once the encapsulation 3 has been completed. The magnetization of the magnetically active core 4 can take place before or after the attachment of the conveying elements 2.

The method according to the disclosure is suitable in particular, but not only, for those rotors 1 which are configured for single use. Once the rotor 1 has been used, the magnetically active core 4 can be separated out and reused for the manufacture of a new rotor 1, wherein this new rotor 1 can then also be configured again for single use.

FIG. 8 shows a schematic sectional illustration of a second exemplary embodiment of a rotor which is manufactured by a method according to the disclosure. This is a rotor 1 which is configured in such a way that it is used for a centrifuge. In this case, the rotor 1 comprises a rotor body 11.

FIG. 9 shows a schematic sectional illustration of a third exemplary embodiment of a rotor which is manufactured by a method according to the disclosure. This is a rotor 1 of a viscosity sensor. This likewise has a rotor body 11.

FIG. 10 shows a schematic sectional illustration of a fourth exemplary embodiment of a rotor which is manufactured by a method according to the disclosure. This is a rotor 1 of a fan. This likewise has a rotor body 11 with fan blades 11a attached thereto.

It goes without saying that identical parts or parts of the exemplary embodiments which are equivalent in terms of function are denoted by the same reference signs. In particular, the reference signs have the same meaning as have already been explained in connection with other exemplary embodiments. It goes without saying that all explanations with respect to the other exemplary embodiments also apply in the same way or analogously in the same way to the respective other exemplary embodiments.

It goes without saying that, after the end of its service life or its use time, the rotor 1 constitutes an impeller 10 which has to be provided for carrying out the method according to the disclosure. That is to say that the exemplary embodiments of rotors shown in FIGS. 8 to 10 can also be recycled and the magnetically active core 4 can be reused. In this case, the dashed lines constitute the separating lines along which the rotor body 11 is separated before the subsequently remaining rest can be provided as an impeller 10 for the method according to the disclosure. It goes without saying that the demagnetization step can also be carried out before the separation.

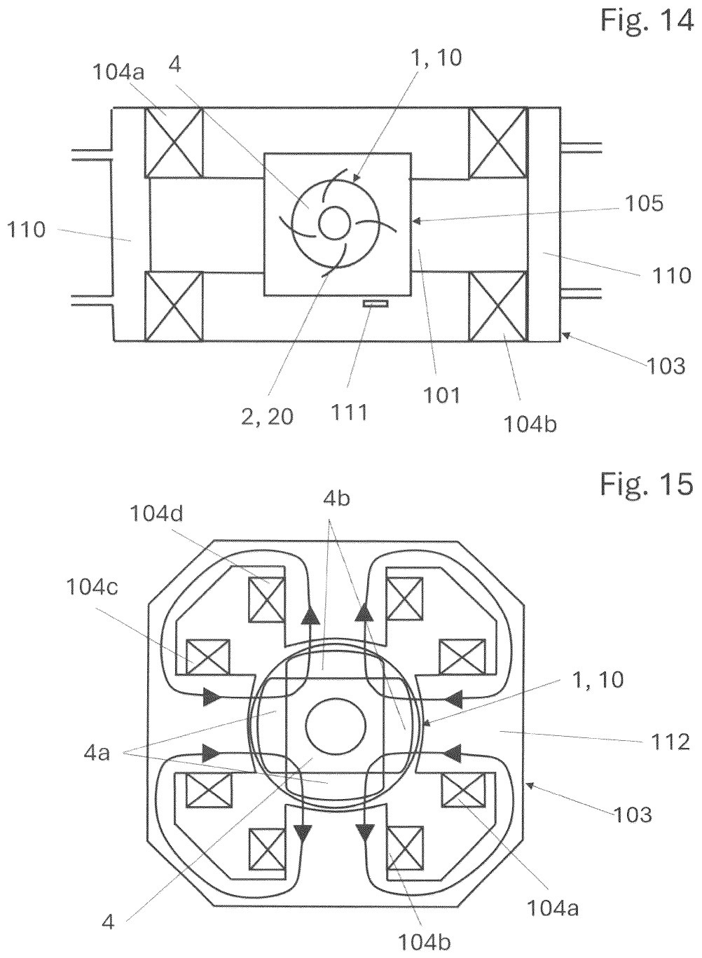

FIG. 11 shows a schematic illustration of a magnetization device 100 with a first variant of a coil unit 103 for carrying out the method according to the disclosure. The magnetization device 100 comprises a generator unit 102, a coil unit 103 and a receptacle 101 into which the impeller 10 and/or the rotor 1 can be inserted and with which the magnetically active core 4 can be demagnetized and/or magnetized. The demagnetization process is explained below. That is to say, an impeller 10 is inserted into the magnetization device, the magnetically active core 4 of which is intended to be demagnetized. The coil unit 103 comprises the receptacle 101 and, in this exemplary embodiment, a coil 104. In other exemplary embodiments, however, configurations with more than one coil 104 are also possible, as illustrated, for example, in the variants in FIGS. 14 and 15. This can be advantageous since, as a result, the homogeneity of the demagnetization/magnetization field can be optimized. In FIG. 14, for example, two coils 104a, 104b are present.

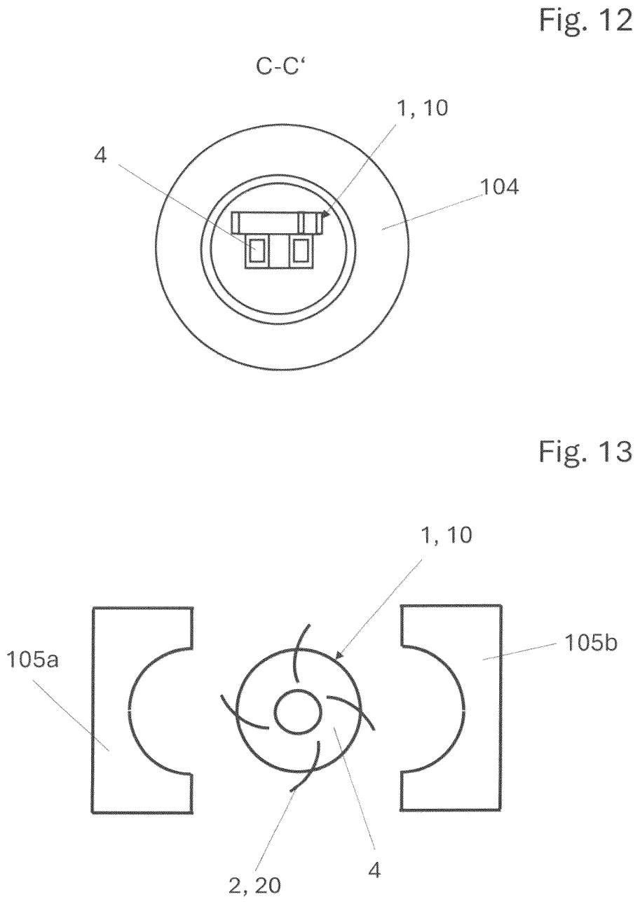

For better understanding, a schematic sectional illustration along the section line C-C′ of the coil unit 103 from FIG. 11 is illustrated in FIG. 12.

In this exemplary embodiment, a fixing element 105 is inserted into the receptacle 101, in which fixing element the impeller 10 is fixed in a predefined position. However, configurations in which the receptacle 101 comprises fixing elements which are fixedly connected to the receptacle 101 are also possible.

As a result of the fixing of the impeller 10, no translational and/or rotational movements of the impeller 10 are possible during the demagnetization/magnetization process. This is advantageous since, as a result, an alignment of the magnetically active core 4 from the predefined arrangement is prevented by the predefined field direction of the demagnetization field over the entire demagnetization process. This is advantageous precisely in the demagnetization since, in this case, an opposing field to the field of the magnetically active core 4 is generated and the latter could rotate as a result without fixing, as a result of which the demagnetization could not function reliably. In this variant of the coil unit 103, the fixing element 105 is configured in two parts, as an upper part 105a and lower part 105b. In this case, the upper part 105a and lower part 105b can be connected to one another by a force-fitting connection and/or a form-fitting connection. These include, inter alia, clamping, pressing, screwing, latching. Closure mechanisms such as, for example, hinges are likewise possible.

FIG. 13 shows a schematic illustration of an opened fixing element 105 for a rotor 1 and/or an impeller 10. In this case, it can be seen that an inner form of the fixing element 105 or of the upper part 105a and of the lower part 105b is adapted to the outer form of the rotor 1 or of the impeller 10, in order to obtain reliable fixing of the rotor 1 or of the impeller 10 in this way. It goes without saying that, in this case, not only circular or semicircular inner forms of the fixing element 105 are possible, but any geometric forms. Thus, the inner form can also be, for example, rectangular and/or oval. The inner form can also have structures which, for example, permit fixing via impeller elements such as, for example, blades. The fixing element 105 is preferably produced from materials which do not interfere with a magnetic field, i.e. have a low magnetic permeability. Furthermore, it is preferred if these materials have a low electrical conductivity in order to avoid shielding effects and/or field distortions by eddy currents.

In other exemplary embodiments, the fixing element 105 can also be of cylindrical configuration. This is advantageous for impellers 10 and/or rotors 1 which have a central opening 43. These can then be simply plugged onto the fixing element 105.

In other exemplary embodiments, the fixing element 105 can also be part of a transport system which comprises at least one fixing element 105, preferably also several fixing elements 105, wherein the transport system is arranged in such a way that the at least one fixing element 105 is conveyed through the coil unit 103. That is to say that the transport system can comprise a conveyor belt on which at least one fixing element 105 is arranged and this conveyor belt then transports the impeller 10 and/or the rotor 1 which is fixed in the fixing element 105 through the magnetic field of the coil unit 103. As a result, a type of conveyor belt work for the demagnetization of the magnetically active core 4 is achieved, as a result of which the demagnetization process can be considerably accelerated.

Furthermore, the receptacle 101 and/or the fixing element 105 can have at least one sensor 111 (FIG. 14) which monitors the demagnetization process. In this case, the at least one sensor 111 can monitor, for example, whether the impeller 10 and/or the rotor 1 is inserted in accordance with the desired predefined position. That is to say that it can measure, for example, the magnetization of the magnetically active core 4. Furthermore, the sensor 111 can measure the course of the demagnetization of the magnetically active core 4. That is to say that the sensor can be a magnetic field sensor.

Preferably, the predefined position constitutes a magnetization position, wherein, in the magnetization position, the magnetization direction MR of the magnetically active core 4 is aligned parallel to one direction RM, wherein the direction RM constitutes the field direction of the demagnetization field.

The generation of the magnetic field is preferably brought about by an oscillating circuit which comprises the magnetization device. In this case, the oscillating circuit comprises at least one resistance component with an electrical resistance R, at least one capacitance component with a capacitance C and at least one inductance component with an inductance I, wherein the oscillating circuit has an oscillating circuit characteristic value SK, wherein the oscillating circuit characteristic value SK must satisfy the relationship

$$SK = \frac{R}{2} \cdot \sqrt{\frac{C}{L}} < 1$$

during the demagnetization. During the magnetization, the oscillating circuit characteristic value SK can have a different value.

In this case, the capacitance component must have a capacitance C which is so large that it can provide sufficient energy for the demagnetization of the magnetically active core 4 together with the charging voltage. The capacitance component preferably comprises at least one capacitor, wherein the capacitor has a capacitor charging voltage which is preferably greater than 1 kV, particularly preferably greater than 2 kV.

The inductance component preferably comprises the coil 104 of the magnetization device 100. The coil 104 must be configured in such a way that the coil interior space is larger than the magnetically active core 4, which is to be demagnetized, of the impeller 10.

The demagnetization of the magnetically active core 4 is preferably brought about by a decaying alternating field. In this case, a magnetic field whose field strength direction is negative with respect to that of the magnetically active core 4 is preferably intended to be generated at the beginning by the magnetization device 100.

The decaying alternating field has a several oscillations, wherein the damping of the decaying alternating field must be selected in such a way that a minimum number of oscillations is present, with the result that a residual magnetic field, which is as low as possible, of the magnetically active core 4 is present at the end of the demagnetization process. This minimum number of oscillations is preferably at least four oscillations, particularly preferably at least six oscillations.

FIG. 14 shows a schematic illustration of a second variant of a coil unit 103. In this variant, the coil unit 103 comprises two coils 104a, 104b. With such a configuration of the coil unit 103, impellers 10 and/or rotors 1 with a single-pole magnetically active core 4 are preferably demagnetized/magnetized. In this exemplary embodiment, the coil unit 103 comprises a cooling means 110 which cools the coils 104a, 104b. The cooling means 110 can be a gas and/or fluid cooling means. For example, air and/or water can be used for cooling. Furthermore, it is possible for the cooling means 110 to be configured as a passive and/or active cooling means 110. Here, the cooling means 110 can be arranged on the coils 104a, 104b, but also within or partially within the coils 104a, 104b.

FIG. 15 shows a schematic illustration of a third variant of a coil unit 103. The impeller 10 or the rotor 1 in this exemplary embodiment has a multipole-pair magnetically active core 4. Here, the magnetically active core 4 has a first pole pair 4a and a second pole pair 4b.

In this exemplary embodiment, a coil core 112 is arranged in the interior of the coils 104a, 104b, 104c, 104d. The coil core 112 is produced from a material which has good magnetic conductivity.

It goes without saying that even larger numbers of poles or pole pairs of the magnetically active core 4 can be demagnetized/magnetized by the magnetization device 100.

It goes without saying that all the exemplary embodiments shown in the description of the figures can be combined with one another in any form with their respective characteristics and components.

What is claimed is:

1. A method for manufacturing a rotor for devices having a magnetically levitated rotor, comprising:
providing an impeller configured to be magnetically levitated, and having a magnetically active core, the magnetically active core completely enclosed by a sheathing, the sheathing comprising a plastic, and at least one impeller element configured to interact with substances is provided on the sheathing;
providing a magnetization device to demagnetize or magnetize the magnetically active core, the magnetization device comprising a receptacle into which the impeller or the rotor is capable of being inserted;
inserting the impeller into the receptacle and demagnetizing the magnetically active core;
separating the magnetically active core from the sheathing;
attaching an encapsulation to the magnetically active core, the encapsulation comprising a plastic and completely enclosing the magnetically active core; and
attaching at least one conveyor element to the encapsulation.

2. The method according to claim 1, wherein the magnetically active core has a magnetization direction, and the magnetization direction is determined before demagnetization of the magnetically active core.

3. The method according to claim 2, wherein the determination of the magnetization direction takes place by a magnetic field measurement or by an identification, attached to the impeller, for the magnetization direction.

4. The method according to claim 2, wherein the inserting of the impeller into the receptacle takes place in an aligned manner, and the alignment takes place on the basis of the determined magnetization direction.

5. The method according to claim 1, wherein the impeller or the rotor is fixed in the receptacle so that no translational or rotational movement of the impeller or of the rotor is possible.

6. The method according to claim 1, wherein demagnetization of the magnetically active core takes place by a decaying alternating field.

7. The method according to claim 6, wherein the decaying alternating field has a frequency, the magnetically active core comprises a permanent-magnetic material, the permanent-magnetic material has a magnetic permeability (μ) and an electrical conductivity (σ), the magnetically active core has an axial extent in an axial direction and a radial extent in a radial direction, the axial direction and the radial direction (R) are arranged perpendicular to one another, the decaying alternating field has a penetration depth (T) into the magnetically active core, the penetration depth is at least equal to half the axial extent or the radial extent, and the frequency satisfies the relationship
$$F < \frac{1}{π \cdot μ \cdot σ \cdot {T}^{2}} .$$

8. The method according to claim 1, wherein the magnetically active core is magnetized after the encapsulation has been attached or after the at least one conveying element has been attached to the encapsulation.

9. A rotor for devices having the magnetically levitated rotor, manufactured using the method according to claim 1.

10. The rotor according to claim 9, wherein the rotor is configured as a single-use part.

11. A magnetizing device for carrying out the method according to claim 1, comprising:
a generator unit;
a coil unit; and
a receptacle into which the impeller or the rotor is capable of being inserted and with which the magnetically active core is capable of being demagnetized or magnetized.

12. The magnetizing device according to claim 11, wherein the coil unit comprises the receptacle and at least one coil.

13. The magnetizing device according to claim 11, wherein a fixing element is configured to be inserted into the receptacle, the fixing element, the impeller or the rotor being configured to be fixed in a predefined position such that no translational or rotational movement of the impeller or of the rotor is possible.

14. The magnetizing device according to claim 13, wherein the predefined position represents a magnetization position, and, in the magnetization position, the magnetization direction of the magnetically active core is aligned parallel to one direction, and the one direction represents a field direction of a magnetization field or of a demagnetization field.

15. The magnetizing device according to claim 11, wherein the magnetizing device comprises an oscillating circuit, the oscillating circuit comprising at least one resistance component with an electrical resistance (R), at least one capacitance component with a capacitance (C) and at least one inductance component with an inductance (L), the oscillating circuit has an oscillating circuit characteristic value (SK), and the oscillating circuit characteristic value (SK) must satisfy the relationship
$$SK = \frac{R}{2} \cdot \sqrt{\frac{C}{L}} < 1$$
during the demagnetization.
